(19) United States
(12) Patent Application Publication
(10) Pub. No.: US 2024/0140668 A1
(43) Pub. Date: May 2, 2024

(54) Zip tie that facilitates convenient fixture

(71) Applicant: Zhijun PENG, Foshan (CN)

(72) Inventor: Zhijun PENG, Foshan (CN)

(21) Appl. No.: 18/200,575

(22) Filed: May 23, 2023

(30) Foreign Application Priority Data
Oct. 28, 2022 (CN) 202211332118.5

(51) Int. Cl. B65D 63/10

(52) U.S. Cl. CPC B65D 63/1072

(57) ABSTRACT

A zip tie which has a head portion, a strap portion, a through hole opened through the head portion, ratchet teeth on the head portion inside the through hole, and teeth provided on the strap portion. At least one mounting lug is provided on the strap portion; each mounting lug is provided on one respective side of an end portion of the strap portion proximal to the head portion; each mounting lug is integrally formed with the strap portion, and each mounting lug has a mounting hole; each and every mounting lug and the head portion are spaced apart and connected by a connecting portion.

### BACKGROUND OF THE INVENTION

The present invention relates to fastening strings or ropes, and more specifically relates to a zip tie for tying objects.

Zip tie is designed for tying objects, and it is designed to prevent untying so that pulling of the zip tie will only result in tying the objects more tightly. Therefore, zip tie is usually non-removable. Of course, removable zip ties are also available in the market. Zip tie can be made of metals (usually stainless steel) or plastics (usually nylon). Zip tie is advantageous in its quick fastening effect, good insulation effect, good self-locking effect, and convenient usage. Therefore, it is widely used for tying connecting wires of televisions or computers in electronics factories, tidying wires in lamps, motors, and electronic toys, fixing and tying oil pipes in mechanical equipment, tying cables in ships, packing bicycles or tying other related objects, and can also be used, for example, in agricultural activities, gardening, and handcrafted artifacts to tie objects, and can further be used for installing and fixing water pipes, underwater pipes, drainages, and cable pipes in construction industry.

In the state of art, a zip tie is only provided for tying objects, but it is not designed to fix tied objects to another object like fixing tied wires onto a wall surface conveniently by using a screw. To solve this problem, CN209126661U has disclosed a zip tie for tying wires, wherein a removable seat, having a mounting hole and a suction cup, is attached to the zip tie, so as to achieve both functions of tying objects and fixing the tied objects to another object. However, the disclosed CN patent has the following deficiencies: 1. The zip tie and the mounting seat have to be separately produced by investing extra money on developing different molds during production, and this results in higher production cost but lower production efficiency. 2. The packaging size is increased to pack both the zip tie and the mounting seat, resulting in higher packaging and transportation costs. 3. It is required to manually install the mounting seat onto the zip tie, and this affects the efficiency during use. 4. The mounting seat attached to the zip tie may easily press against and thus damage the objects being tied.

### BRIEF SUMMARY OF THE INVENTION

In view of the aforesaid disadvantages now present in the prior art, the present invention provides a zip tie that facilitates convenient fixture. According to the present invention, at least one mounting lug is provided on a strap portion of the zip tie; each mounting lug is provided on one respective side of an end portion of the strap portion proximal to a head portion of the zip tie; each mounting lug is integrally formed with the strap portion, and each mounting lug has a mounting hole; each and every mounting lug and the head portion are spaced apart and connected by a connecting portion. As such, when using the zip tie of the present invention to tie objects, the mounting lug(s) will not directly tighten onto the objects being tied since the mounting lug(s) are provided on the side(s) of the strap portion, and hence, the mounting lug(s) will not directly press against the objects being tied which may otherwise damage the objects being tied. On the other hand, production cost is lower because only one mold is required to manufacture the zip tie of the present invention comprising the mounting lug(s). It is also not required to assemble the mounting lug(s) to the zip tie in the present invention, and the overall size of the zip tie comprising the mounting lug(s) is only slightly bigger than the zip tie without the mounting lug(s). Besides, connecting portion is provided so that when screw(s) pass through the mounting lug(s) and being hammered to another surface, the screw(s) can easily pass through the mounting lug(s) without impacting on the head portion which may otherwise loosen the tying effect of the zip tie.

The present invention is achieved as follows: The zip tie of the present invention comprises a head portion, a strap portion, a through hole opened through the head portion, ratchet teeth disposed on the head portion inside the through hole and teeth provided on the strap portion; wherein at least one mounting lug is provided on the strap portion; each mounting lug is provided on one respective side of an end portion of the strap portion proximal to the head portion; each mounting lug is integrally formed with the strap portion, and each mounting lug has a mounting hole; each and every mounting lug and the head portion are spaced apart and connected by a connecting portion.

Further, said at least one mounting lug comprises two mounting lugs provided respectively on two sides of the end portion of the strap portion proximal to the head portion.

Further, a height of the connecting portion is equal to a width of the strap portion.

The present invention has the following beneficial advantages: According to the present invention, at least one mounting lug is provided on the strap portion of the zip tie; each mounting lug is provided on one respective side of the end portion of the strap portion proximal to the head portion of the zip tie; each mounting lug is integrally formed with the strap portion, and each mounting lug has a mounting hole; each and every mounting lug and the head portion are spaced apart and connected by a connecting portion. As such, when using the zip tie of the present invention to tie objects, the mounting lug(s) will not directly tighten onto the objects being tied since the mounting lug(s) are provided on the side(s) of the strap portion, and hence, the mounting lug(s) will not directly press against the objects being tied which may otherwise damage the objects being tied. On the other hand, production cost is lower because only one mold is required to manufacture the zip tie of the present invention comprising the mounting lug(s). It is also not required to assemble the mounting lug(s) to the zip tie in the present invention, and the overall size of the zip tie comprising the mounting lug(s) is only slightly bigger than the zip tie without the mounting lug(s). Besides, connecting portion is provided so that when screw(s) pass through the mounting lug(s) and being hammered to another surface, the screw(s) can easily pass through the mounting lug(s) without impacting on the head portion which may otherwise loosen the tying effect of the zip tie. The present invention is simple in structure, low in production cost, and convenient to use. The zip tie of the present invention has a size not so different from a conventional zip tie so as to facilitate packaging and transportation as well as fixture of tied objects on another object.

### BRIEF DESCRIPTION OF THE DRAWINGS

FIG. 1 is a perspective view of the zip tie when it is not in use.

FIG. 2 is a perspective view of the zip tie when being used to tie objects.

FIG. 3 is a cross section view along A-A in FIG. 1.

### DETAILED DESCRIPTION OF THE INVENTION

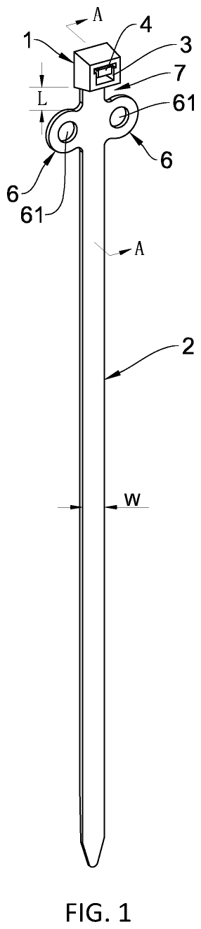

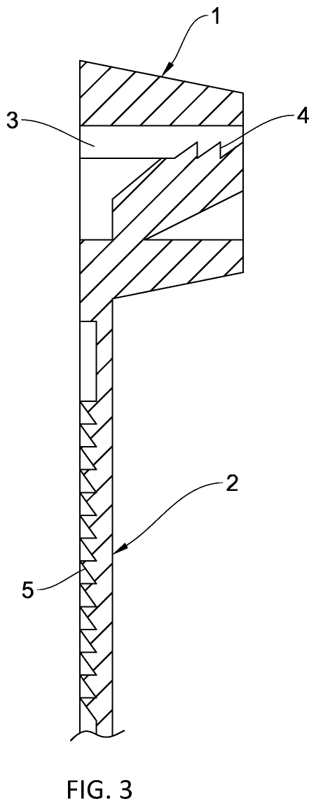

As shown in FIG. 1 to FIG. 3, the zip tie of the present invention comprises a head portion 1, a strap portion 2, a through hole 3 opened through the head portion 1, ratchet teeth 4 disposed on the head portion 1 inside the through hole 3, and teeth 5 provided on the strap portion 2. These components are the ordinary components found in a conventional zip tie.

To achieve the objects of the present invention, at least one mounting lug 6 is provided on the strap portion 2; each mounting lug is provided on one respective side of an end portion of the strap portion 2 proximal to the head portion 1; each mounting lug 6 is integrally formed with the strap portion 2, and each mounting lug 6 has a mounting hole 61; each and every mounting lug 6 and the head portion 1 are spaced apart and connected by a connecting portion 7. As such, when using the zip tie of the present invention to tie objects, the mounting lug(s) 6 will not directly tighten onto the objects being tied since the mounting lug(s) 6 are provided on the side(s) of the strap portion 2, and hence, the mounting lug(s) 6 will not directly press against the objects being tied which may otherwise damage the objects being tied. On the other hand, production cost is lower because only one mold is required to manufacture the zip tie of the present invention comprising the mounting lug(s) 6. It is also not required to assemble the mounting lug(s) 6 to the zip tie in the present invention, and the overall size of the zip tie comprising the mounting lug(s) 6 is only slightly bigger than the zip tie without the mounting lug(s) 6. Besides, connecting portion 7 is provided so that when screw(s) pass through the mounting lug(s) 6 and being hammered to another surface, the screw(s) can easily pass through the mounting lug(s) 6 without impacting on the head portion 1 which may otherwise loosen the tying effect.

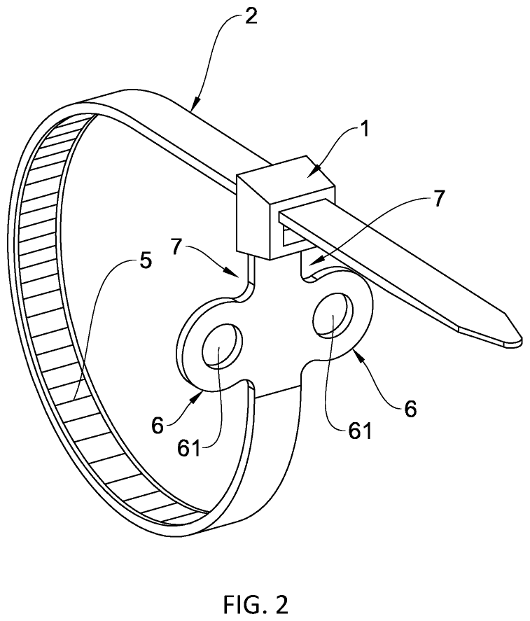

As shown in FIG. 1 and FIG. 2, said at least one mounting lug 6 comprises one single mounting lug provided on one side of the end portion of the strap portion 2 proximal to the head portion 1; alternatively, said at least one mounting lug 6 comprises two mounting lugs 6 provided respectively on two sides of the end portion of the strap portion 2 proximal to the head portion 1. These two configurations can be alternatively employed according to practical needs.

In order to constrain the size of the zip tie and minimize the space occupied by the zip tie during use, a height L of the connecting portion 7 is equal to a width of the strap portion 2. During use, the greater the width of the strap portion 2, the greater the height L of the connecting portion 7; on the contrary, the smaller the width of the strap portion 2, the smaller the height L of the connecting portion 7.

What is claimed is:

1. A zip tie, comprising a head portion, a strap portion, a through hole opened through the head portion, ratchet teeth disposed on the head portion inside the through hole, and teeth provided on the strap portion; wherein at least one mounting lug is provided on the strap portion; each mounting lug is provided on one respective side of an end portion of the strap portion proximal to the head portion; each mounting lug is integrally formed with the strap portion, and each mounting lug has a mounting hole; each and every mounting lug and the head portion are spaced apart and connected by a connecting portion.

2. The zip tie of claim 1, wherein said at least one mounting lug comprises two mounting lugs provided respectively on two sides of the end portion of the strap portion proximal to the head portion.

3. The zip tie of claim 1, wherein a height of the connecting portion is equal to a width of the strap portion.
